(19) United States
(12) Patent Application Publication
(10) Pub. No.: US 2026/0006043 A1
(43) Pub. Date: Jan. 1, 2026

(54) SYSTEM AND METHOD OF ADVANCED EVENT RANKING AND CORRELATION FOR THREAT DETECTION

(71) Applicant: Acronis International GmbH, Schaffhausen (CH)

(72) Inventors: Filip Olszak, Singapore (SG); Serg Bell, Costa del Sol (SG); Stanislav Protasov, Singapore (SG)

(21) Appl. No.: 18/758,329

(22) Filed: Jun. 28, 2024

(51) Int. Cl. H04L 9/40

(52) U.S. Cl. CPC H04L 63/1416; H04L 63/1425

(57) ABSTRACT

Systems and methods for advanced event ranking and correlation for threat detection. A method includes real-time processing of events with stateful threat detection, combining immediate detection capabilities with sophisticated threat analysis. A method further includes multi-stage processing in a detection engine, where generic events from endpoint detection and response (EDR) agents are scored and enriched to provide extended context based on machine learning models for event scoring, enriched events correlation, and applying security rules to detect threats.

### TECHNICAL FIELD

The invention relates generally to threat detection. More particularly, the invention relates to systems and methods for advanced event ranking and correlation for threat detection, including real-time processing, stateful threat detection, and multi-stage event analysis using machine-learning models for event scoring and enrichment.

### BACKGROUND

Traditional detection solutions include endpoint agents, security information and event management (SIEM) systems, endpoint detection and response (EDR) systems, and extended detection and response (XDR) systems.

Endpoint agents are deployed directly on computing devices to monitor and analyze activities for patterns of malicious behavior. Endpoint agents provide real-time protection by detecting threats based on predefined rules and behavioral analysis. However, endpoint agents often operate in isolation, limiting their ability to correlate events across multiple devices and providing only a local view of security incidents.

SIEM systems aggregate and analyze security data from multiple sources within an organization environment. SIEM systems provide centralized logging, real-time monitoring, and advanced analytics to detect and respond to security incidents. While SIEM systems offer a broad perspective by integrating data from various endpoints and network devices, they have challenges in handling large volumes of data and generating actionable insights in real-time.

EDR systems enhance the capabilities of endpoint agents by providing more advanced threat detection, investigation, and response functionalities. EDR systems collect and analyze data from endpoints to identify potential threats and provide forensic information for incident response. EDR systems enable better visibility into endpoint activities in comparison with endpoint agents and support more sophisticated detection mechanisms, but EDR systems have limitations in correlating events across multiple endpoints and integrating data from non-endpoint sources.

XDR systems extend the capabilities of EDR systems by integrating data from multiple security layers, including endpoints, networks, and cloud environments. XDR systems provide a unified approach to threat detection and response by correlating events from various sources and offering a comprehensive view of security incidents. Despite the enhanced capabilities, XDR systems encounter several technical challenges that limit their effectiveness.

Traditional rule-based detection engines of detection solutions, such as EDR, XDR and SIEM, require extensive manual configuration and custom code to manage complex use cases. Manual configuration makes the detection logic difficult to maintain, test, and update. Ensuring that detection rules operate as expected and measuring their impact on overall system performance becomes a challenge due to the manual nature of configurations.

Pattern-matching performance is critical for efficient threat detection. Current systems use pattern-matching algorithms to evaluate events against detection rules. Pattern-matching algorithms face performance issues due to the high volume and variety of events. Events frequently lack sufficient contextual information, necessitating external calls for additional data, which introduces delays. The inability to consistently produce optimized event data for processing leads to performance degradation, impacting overall efficiency of the system.

Machine-learning-based detection engines introduce several limitations that impact their effectiveness in threat detection and response. One significant limitation is the inability to tune the solution rapidly. Machine-learning (ML) models require substantial time and effort to retrain and deploy, making it challenging to adjust detection parameters quickly in response to emerging threats. Additionally, detection engines often lack granular detection control, making it difficult to determine the specific reasons behind an alert. The opaque nature of ML models means that understanding why an alert was registered necessitates a full-cycle investigation, which can be time-consuming and resource-intensive. Another limitation is that ML inference-based detection engines do not typically analyze historical data in the course of baselining, which results in a lack of contextual understanding of long-term patterns and behaviors, which are needed for efficient incident response and ML models retraining.

Resource consumption on endpoints and detection engines is a concern. Processing security events requires substantial computational resources, which can strain endpoint performance and reduce the efficiency of detection engines. High resource consumption limits the scalability of security solutions and hampers the ability to process events in real-time. Scalability poses a significant problem for security solutions, particularly when they need to support a large number of endpoints and process all events within a single detection engine. As the number of endpoints increases, the volume of event data generated grows exponentially, overwhelming the detection engine. The inability to efficiently manage and preprocess a vast amount of event data exacerbates the problem, as the detection engine must handle every event generated by each endpoint, wasting resources for processing data with zero impact on threat detection analysis.

Event enrichment can provide context to security events and can enhance threat detection accuracy. However, enriching events locally on endpoints is challenging due to the computational overhead and the need for frequent updates to lookup tables and ML models. Without adequate enrichment, detection engines struggle to distinguish between false positives and genuine threats, reducing the overall effectiveness of the security system.

Prioritizing security jobs and rapidly detecting threats are essential for minimizing the impact of security incidents. Current systems often lack effective mechanisms to prioritize events based on risk levels. The deficiency leads to delayed responses and increased exposure to threats.

To address the technical challenges, a resource-optimized, context-driven, automated and configurable threat detection and mitigation solution that enhances the accuracy, efficiency, and scalability of detection engines, providing a robust defense against sophisticated security threats, is needed.

### SUMMARY

Embodiments described or otherwise contemplated herein substantially meet the aforementioned needs of the industry.

In an embodiment, a method for adaptive threat detection in a computing system comprising a microprocessor, memory, and a plurality of endpoints comprises collecting events on the endpoints and sending the events to an event router; processing the events on the event router under program control of the microprocessor in the form of a persistent event stream, wherein the processing includes: normalizing the events and assigning topics to the events to prioritize event enrichment operations and subsequent detection engine operations based on event scores; scoring the events from the persistent event stream using at least one of a lookup tables, a serialized machine learning model or a baselining machine learning model; enriching generic events at an event enrichment unit with event data correlated with the generic events using at least one of the lookup tables or the baselining machine learning model, wherein the enriching is prioritized according to the event score and at least one related topic; processing enriched scored events in a detection engine, wherein the processing includes: detecting a first detection in the persistent event stream within a first time window, correlating the registered first detection with other events in the persistent event stream within a second time window, and detecting a second detection of correlation with higher severity than the first detection; and registering a security incident when the second detection has a severity higher than a predefined threshold; wherein the baselining machine learning model, the serialized machine learning model, the lookup table, and the machine learning-based detection engine use the exact event data in exact event format.

In an embodiment, a system for adaptive threat detection in a computing system comprises an endpoint detection and response (EDR) agent configured to collect events on an endpoint and transfer the events to an event router; at least one processor and memory operably coupled to the at least one processor; instructions that, when executed by the at least one processor, cause the at least one processor to implement: the event router, the event router configured to process the events in the form of a persistent event stream, wherein the processing includes: normalizing the events and assigning topics to the events to control the event enrichment pipeline and prioritize subsequent operations based on event scores; an event scoring unit configured to score the events from the persistent event stream using lookup tables and infer a security risk score for each event, wherein the scoring is performed using serialized machine learning models and baselining machine learning models; an event enrichment unit configured to enrich generic events with event data correlated with the generic events using the baselining machine learning model, wherein the enrichment is performed in a prioritized manner according to the event score and at least one related topic; a detection engine configured to process enriched scored events, wherein the processing includes: detecting a first detection in the persistent event stream within a first time window, correlating the registered first engine detection with other events in the persistent event stream over a second time window, detecting a second detection of correlation with higher severity than the first engine detection, and registering a security incident when the second detection has a severity higher than a predefined threshold; wherein the baselining machine learning model, serialized machine learning model, lookup table, and machine learning-based detection engine use the exact event data in exact event format.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system of event scoring and correlation for threat detection, in accordance with an embodiment.

FIG. 2 is a block diagram of a system of advanced event scoring and correlation for threat detection, in accordance with an embodiment.

FIG. 3A is a data flow diagram of a threat detection system, in accordance with an embodiment.

FIG. 3B is a data flow diagram of a threat detection system with event correlation, in accordance with an embodiment.

FIG. 3C is a data flow diagram of a threat detection system with advanced event scoring, in accordance with an embodiment.

FIG. 4A is a block diagram of a data structure for ML-based event analysis, in accordance with an embodiment.

FIG. 4B is a block diagram of a data structure for ML-based event analysis with external event sources, in accordance with an embodiment.

FIG. 5 is a block diagram of an event enrichment and event scoring subsystem, in accordance with an embodiment.

FIG. 6 is a flowchart of a method of advanced event scoring and correlation for threat detection, in accordance with an embodiment.

The embodiments described are exemplary ways to use the invention to solve technical problems in the field of the invention. The solutions and techniques disclosed may also be used to solve other problems in the field or to solve similar problems in other fields. Substitutions, modifications, and equivalents known to those of skill in the art may be used to implement these solutions and techniques, consistent with scope of the invention described in the claims.

### DETAILED DESCRIPTION

Systems and methods implement advanced event ranking and correlation for threat detection within various computing systems and networks. The present disclosure relates to systems and methods for optimizing security through the scoring, prioritization, and correlation of security events. Ranking in context of the present description means scoring and prioritizing events in workflow operations. In particular, the present disclosure relates to systems and methods for advanced event scoring and correlation for threat detection, which enhances the accuracy and efficiency of identifying and mitigating security threats. By leveraging ML models for event scoring and prioritization, systems promptly address the most critical threats.

Embodiments can be implemented in a staged approach. In a first stage, raw security events are collected and normalized from multiple endpoints. In a subsequent stage, normalized events are enriched and scored based on their risk level using ML models. A final stage includes correlating the scored events within a detection engine to detect potential security threats and prioritize response actions accordingly.

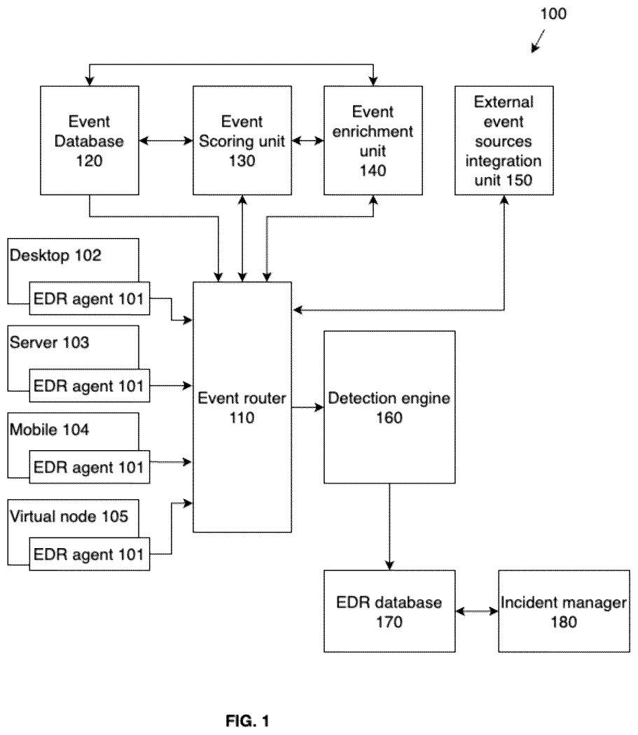

FIG. 1 is a block diagram of a system 100 for event scoring and correlation for threat detection, in accordance with an embodiment. The system 100 generally comprises EDR agents 101 for data collection, an event router 110 for normalization and event routing between system units, an event scoring unit 130 for event risk assessment, referred to as event scoring, an event enrichment unit 140 for adding context to collected events, and a detection engine 160 for threat analysis. The components are interconnected to provide a comprehensive security solution that effectively responds to and mitigates sophisticated cyber threats in a prioritized way with enhanced detection capabilities. In embodiments, system 100 can include at least one processor, memory operably coupled to the at least one processor, and instructions that, when executed by the at least one processor, cause the at least one processor to execute the system 100 components described herein, including event router 110, event scoring unit 130, event enrichment unit 140, and detection engine 160, and others, as will be described with respect to system 100 (e.g. external event sources integration unit 150, incident manager 180, etc.).

Referring to FIG. 1, system 100 comprises EDR agents 101 deployed on different types of endpoints, such as desktop 102, server 103, mobile 104, and virtual node 105. The EDR agents 101 monitor and collect raw security events from customer network endpoints and transmit the events to an event router 110. In certain embodiments, each endpoint can include its own processor and memory including instructions to execute the respective EDR agent 101. In other embodiments, EDR agent 101 can utilize other processing resources such as the at least one processor and memory of system 100 described above.

In an embodiment, EDR agents 101 can be implemented as user applications, drivers, embedded services in hardware, or containers with specific processes configured to monitor security events. In an embodiment, EDR agents 101 are lightweight and perform minimal analysis on the endpoint to detect simple threats. In an exemplary embodiment, EDR agents 101 can analyze events of a single process to detect a threat. In another exemplary embodiment, EDR agents 101 analyze endpoint events in a short-term time window, referred to as first time window, to detect a threat. For example, if suspicious events are registered in the endpoint within an hour, a threat is detected. Lightweight EDR agent architecture is advantageous compared to traditional security agents that often perform complex correlation and pattern-based analysis locally. Such intensive processing tasks are resource-consuming because they require significant computational power and memory to match event flow with many threat features, like behavioral patterns or correlations, which can slow down the performance of the endpoint.

In an embodiment, EDR agents 101 apply event normalization rules to generate generic events. Normalization can include structuring, parsing, and converting raw event data into a standardized format, thereby making events from different sources consistent. The normalization rules can be updated to support new event types, allowing the system 100 to adapt to evolving security needs. For example, an EDR agent 101 can capture various types of raw events such as process starts, file accesses, network connections, and registry changes. Raw events can vary in format and content depending on the source. In one embodiment, the EDR agent 101 applies predefined normalization rules to convert raw events into a standardized generic event format, including parsing the raw data to extract relevant fields, structuring the data into a consistent schema, and applying any necessary transformations to support uniformity. In other embodiments, normalization rules are defined or adapted after system implementation. By normalizing events at the endpoint, the event router 110 receives already normalized generic events, reducing the overall latency of the system 100. The normalized events are easier to enrich, score, and correlate in subsequent processing stages, improving the accuracy and effectiveness of threat detection.

In another embodiment, EDR agents 101 can also include basic event merging and filtering capabilities to reduce the volume of data transmitted to the event router. By applying simple filters, EDR agents 101 can discard irrelevant or low-priority events, ensuring that only significant events are processed further, reducing the load on the network and subsequent processing units, thereby contributing to a more scalable and efficient security system.

Event router 110 is configured for the routing of security events within the system. The event router receives generic events from EDR agents 101 and directs generic events to subsequent units for further analysis. In an embodiment, event router 110 receives threat detections from detection engine 160 and forwards it for the enrichment or for the scoring as a new generic event.

In an embodiment, event router 110 performs the task of routing the received events to the appropriate processing units, such as the event scoring unit 130, event enrichment unit 140, and detection engine 160. The event router acts as a central hub, ensuring that events are distributed to the correct components based on predefined rules and the nature of the events.

In one embodiment, event router 110 generates a persistent event flow or stack accessible by other system units for subsequent operations. A persistent event flow acts as a list of event currently in operation, allowing units such as the event scoring unit 130, event enrichment unit 140, and detection engine 160 to access, analyze, and process the events in real-time.

In an embodiment, event router 110 is implemented as a software application running on a dedicated server or as a cloud-based service. It leverages high-performance networking and computing resources to handle large volumes of security events in real-time. The event router utilizes advanced queuing and load-balancing techniques to manage event traffic efficiently and prevent bottlenecks.

In another embodiment, event router 110 can apply additional processing to the events, such as deduplication and preliminary filtering. In an embodiment, duplicated events are identified and merged, reducing the overall volume of events to be processed. Preliminary filtering can include discarding events deemed irrelevant or low-priority based on predefined criteria. Preliminary event filtering reduces the load on subsequent processing units and enhances the overall efficiency of the system.

In an embodiment, event router 110 supports scalability by distributing event processing across multiple nodes or instances. A distributed architecture allows the system 100 to handle increased event volumes and support high availability and fault tolerance. By scaling horizontally, the event router 110 can maintain optimal performance even under heavy load conditions.

In an embodiment, event router 110 is configured to be extensible, allowing for the integration of additional event sources, third-party services or additional detection engines 160, thereby extending the environmental context in operation and allowing real-time integrated event processing.

In an embodiment, event router 110 maintains a comprehensive logging and monitoring mechanism to track event flow and system performance. In an embodiment, all events received by the event router are stored in event database 120 that collects events from all EDR agents and connected 3rd party event sources. In another embodiment, selected (e.g. not all) events are stored in event database 120.

In an embodiment, event database 120 serves as the central repository for all events received by event router 110. Event database 120 is configured to store events in a structured and efficient manner, allowing quick retrieval and analysis. Event database 120 is implemented using high-performance database technologies capable of handling large volumes of data with low latency and high throughput. Examples of currently available databases that meet these criteria to varying degrees include MongoDB, Redis, Couchbase, HBase, PostgreSQL, MariaDB, MySQL, Elasticsearch, Amazon DynamoDB, and Microsoft SQL Server.

In an embodiment, event database 120 supports both short-term and long-term storage of events. Short-term storage is optimized for real-time access and quick queries, facilitating immediate analysis and response by other system components. Long-term storage retains historical event data, which can be used for retrospective analysis, ML model training, and compliance reporting. The dual storage strategy helps the system maintain high performance while also preserving valuable historical data.

In an embodiment, event database 120 provides robust indexing and querying capabilities. Events are indexed based on various attributes such as timestamp, event type, source, and event score. Event indexing facilitates efficient query execution, allowing rapid retrieval of specific events or event types for analysis. Additionally, the event database 120 supports complex queries and aggregations, allowing for advanced data analysis and reporting.

Event scoring unit 130 is configured to assess the risk level of events and/or calculate a score indicating the anomalous nature of events compared to other events with an appropriate confidence level. Event scoring unit 130 can leverage various methodologies, including ML models, statistical event counters, and historical event database views, to perform event ranking.

In an embodiment, event scoring unit 130 utilizes ML models trained on historical event data to identify patterns and anomalies. Event scoring ML models can be continuously updated with new data to improve their accuracy and relevance. For example, continuous updating can include a time-based update (e.g. daily, weekly, monthly), an event-based update (e.g. after certain ML model evaluation(s), or after certain thresholds (e.g. under 95%, 75%, 50%, or 25% identification rate). The scoring process includes analyzing the attributes of each event, such as source, type, frequency, and contextual information, to determine its risk level. The assigned score reflects the likelihood that the event represents a security threat.

In another embodiment, event scoring unit 130 can operate based on statistical event counters that includes maintaining counters for various event types and their attributes, which are then used to calculate the event score. For example, the event scoring unit 130 can track the frequency of certain types of events over time and compare the current event frequency to historical data. Significant deviations from the norm can indicate an anomalous event, resulting in a higher risk score.

The event scoring unit 130 can provide a quantified assessment of the event risk level, allowing other system components to prioritize their processing efforts accordingly. In an embodiment, the risk score assigned by the event scoring unit is used for determining the order in which events are processed and investigated.

In an embodiment, the event scoring unit 130 considers the environmental context of the events. Environmental context is derived from the collected events and enriched data, reflecting the specific conditions and activities within the monitored environment. For example, an event occurring on a high-risk endpoint or during an unusual time period receives a higher score. The context helps to differentiate between benign and potentially malicious events, thereby enhancing the accuracy of the scoring process.

The environmental context additionally applies to events in operation including factors such as the behavior patterns of users and endpoints, network activity, and historical trends. By considering such factors, the event scoring unit 130 can adjust the scores to reflect the current security landscape accurately. Such an adaptive scoring mechanism allows the system 100 to be responsive to changing conditions and effectively identify emerging threats.

In an embodiment, event enrichment unit 140 enhances the collected and normalized events by adding additional context and relevant information from various internal and external sources. Event enrichment unit 140 can provide a more comprehensive view of each event in operation, thereby improving the accuracy and effectiveness of the subsequent threat detection process.

In an embodiment, event enrichment unit 140 interfaces with internal data sources such as historical event databases and user behavior analytics systems. By correlating a current event with historical data, the event enrichment unit 140 can add contextual information such as past occurrences of similar events, associated user activities, and historical threat patterns. Event contextual information helps to differentiate between benign and potentially malicious events.

In another embodiment, event enrichment unit 140 integrates external data sources such as threat intelligence feeds, third-party security databases, and real-time alerts from external security providers. Third-party sources provide additional context on emerging threats, known attack vectors, and indicators of compromise. By operating with external data, event enrichment unit 140 can enhance the event with information about the latest security threats and vulnerabilities, thereby improving the accuracy of the risk assessment.

The enriched data added by event enrichment unit 140 includes details such as the geographic location of the event source, the reputation of the involved IP addresses, the prevalence of similar events across different environments, and the typical behavior patterns associated with the event type.

In an embodiment, the enrichment process includes both real-time enrichment of incoming events and periodic enrichment of stored events. Real-time enrichment immediately enhances event flow with the latest contextual information as they are processed by the system 100. Periodic enrichment includes updating the contextual information for stored events based on newly available data.

In an embodiment, a generic event processed at EDR agent 101, event router 110, event enrichment unit 140, and event scoring unit 130 serves as an abstraction that includes only fields common to all enriched events. For example, in the context of a Windows EDR agent, the generic event contains process information since all events (e.g., network events, file operations) can be associated with a specific process. The generic event for a Windows EDR agent includes fields such as: id: UUID; event_time: DateTime; host_name: String; agent_id: UUID; customer_uuid: UUID; customer: String; cluster_id: Integer; parent_name: String; parent_oname: String; parent_args: String; parent_path: String; parent_pid: Integer; parent_start: DateTime; parent_gpid: UUID; parent_md5: String; proc_name: String; proc_oname: String; proc_args: String; proc_path: String; proc_user: String; proc_upn: String; proc_pid: Integer; proc_start: DateTime; proc_gpid: UUID; proc_md5: String.

A specific event type, such as a network event, extends the generic event by adding fields unique to network operations, including: protocol: String; net_dst_ip: String; net_dst_port: Integer; net_src_ip: String; net_src_port: Integer; net_src_iot: Boolean; net_src_name: String; net_src_mac: String; net_src_iot_vn: String; net_src_iot_cat: String.

In an embodiment, events processed by the EDR agent 101 and sent to the event router 110 are initially in a FlatBuffer format. The FlatBuffer format is a binary buffer that contains nested objects such as structs, tables, and vectors. These objects are organized using offsets, allowing data to be traversed in place, similar to traditional pointer-based data structures. This arrangement is known as “zero-copy” deserialization, which makes accessing data in these formats much faster than data in formats requiring more extensive processing, such as JSON, CSV, and in many cases Protocol Buffers. FlatBuffer format allows optimizing data transmission by not repeatedly sending all fields for every operation. Instead, the event router 110 includes a cache component that caches repeating process information based on a unique key. Cached data is then joined with the specific event information for use in a centralized detection engine.

In another embodiment, the event enrichment unit 140 extends generic events with additional context. For example, the event enrichment unit 140 can use baselining ML models to generate enriched events with extended fields such as: enriched event context—additional metadata or threat intelligence related to the event; score parameter—risk score or anomaly score generated by the event scoring unit 130; and external event correlation—links to external events or alerts that provide further context.

Enriched events are then used by the detection engine 160 to apply correlation rules and detection algorithms. The detection engine 160 utilizes the extended context provided by enriched events and event scores to enhance threat detection accuracy. The detection engine 160 correlates the events to identify potential security threats. The detection engine 160 prioritizes the analysis based on the risk scores assigned during the event scoring stage. Detected threats are recorded in an EDR database 170 and managed by an incident manager 180 for appropriate response actions.

In an embodiment, event enrichment unit 140 can be implemented as a software module deployed on a dedicated server within the network infrastructure. Event enrichment unit 140 is configured for real-time data processing and integration with internal and external data sources. In another embodiment, event enrichment unit 140 can be implemented as a cloud-based service, leveraging cloud resources for scalability and high availability.

In another embodiment, event enrichment unit 140 can be deployed as a containerized application within a microservices architecture. Each container can handle specific enrichment tasks, such as fetching data from threat intelligence feeds or querying user behavior analytics systems. Microservice architecture is an architectural style for developing applications. It allows a large application to be separated into smaller independent parts, with each part having its own realm of responsibility. In a microservices architecture, each microservice is a single service built to accommodate an application feature and handle discrete tasks. Each service is a separate codebase, which can be managed by a small development team. Services can be deployed independently, meaning a team can update an existing service without rebuilding and redeploying the entire application. Services communicate with each other using well-defined APIs, and internal implementation details of each service are hidden from other services. This architecture supports polyglot programming so that different services do not necessarily require the same technology stack, libraries, or frameworks. Microservice architecture of event enrichment unit 140 allows for easy scaling and maintenance, thus ensuring that the enrichment process remains efficient and up-to-date with the latest security information.

In an embodiment, event enrichment unit 140 operates with the persistent event flow provided by event router 110. Persistent event flow allows event enrichment unit 140 to continuously access and process events in real-time, ensuring that each event is enriched with the most up-to-date contextual information. By leveraging the persistent event flow, the enrichment unit can dynamically integrate data from both internal and external sources, such as historical event databases, threat intelligence feeds, and user behavior analytics systems.

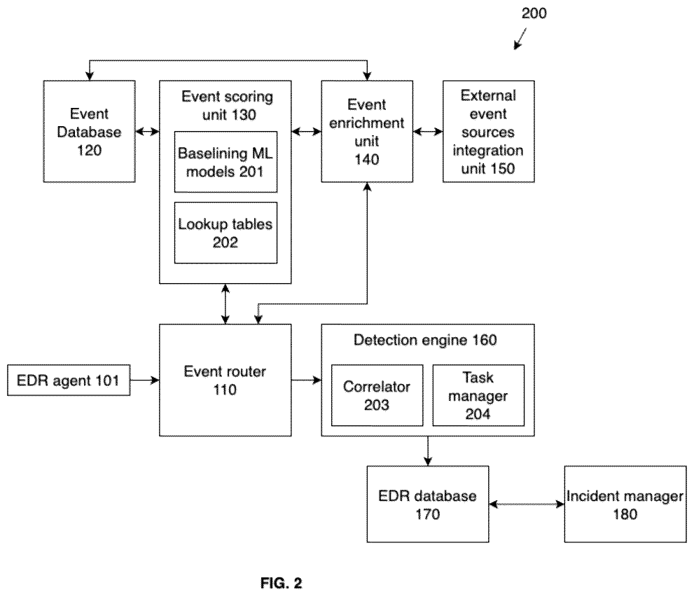

Referring to FIG. 2, a block diagram of a system 200 for advanced event scoring and correlation for threat detection is depicted, in accordance with an embodiment. FIG. 2 depicts the advanced capabilities of the event scoring unit 130 and the detection engine 160 within the system.

In an embodiment, event scoring unit 130 uses ML models and statistical analysis to evaluate the risk level of security events. The advanced capabilities of event scoring unit 130 include the use of baselining ML models 201 and lookup tables 202 to assess and rank the events.

In an embodiment, baselining ML models are specialized ML models configured to establish a baseline of normal behavior patterns within a network or system. Baselining ML models are specialized ML models trained using historical event data stored in event database 120. The training process includes feeding the models with datasets of historical events, allowing the models to learn and identify patterns associated with both normal and anomalous activities. The inputs to baselining ML models 201 include event attributes such as source, type, frequency, and contextual information derived from event enrichment unit 140. The outputs of baselining ML models 201 are risk scores indicating likelihood that an event represents a security threat. Examples of ML model types used to implement baselining ML models include anomaly detection models, time-series analysis models, and clustering algorithms.

In another embodiment, serialized ML models can be used instead of baselining ML models. Though baselining ML models 201 is depicted in FIG. 2, both baselining ML models and/or serialized ML models can be implemented in system 200. Serialized ML models are ML models trained, optimized, and stored in a serialized format for efficient deployment and execution. Serialized ML models are trained on the same historical events from event database 120 as baselining ML models 201. The training process includes optimizing the models for quick loading and execution, allowing the models to be stored and transmitted as compact binary files. The inputs to serialized ML models include the same event attributes as baselining ML models 201: source, type, frequency, and contextual information derived from event enrichment unit 140. The outputs of serialized ML models are also risk scores indicating the likelihood that an event represents a security threat. Examples of ML model types used to implement serialized ML models include decision trees, random forests, and gradient boosting machines.

In an embodiment, baselining ML models and serialized ML models differ primarily in their deployment and execution approaches. Baselining ML models are configured to continuously learn and adapt to changes in the system 200 by incorporating new data over time, making baselining ML models ideal for recognizing long-term trends and deviations from the norm. In contrast, serialized ML models are pre-trained, optimized for efficient deployment, and executed as compact binary files, providing immediate, on-the-fly risk assessment based on the latest trained models and threat intelligence.

In another embodiment, both types of ML models are used in event scoring unit 130. Utilizing both baselining and serialized ML models provides several technical advantages. Baselining ML models offer a deep understanding of normal behavior patterns and long-term trends, ensuring the system adapts to gradual changes in the environment. Serialized ML models provide real-time risk assessment and scoring, allowing the system 200 to respond quickly to emerging threats with the latest detection algorithms. The parallel operations of both types of ML models enhances the overall effectiveness and responsiveness of event scoring unit 130, ensuring comprehensive risk assessment and threat detection capabilities by leveraging both historical and real-time data.

Lookup tables 202 are used to store pre-calculated scores and statistical data in a table view, which facilitate real-time event scoring. Lookup tables 202 include information derived from the baselining ML models, including thresholds, frequency distributions, and anomaly scores. When a new event is processed by the event scoring unit 130, the lookup tables 202 provide quick reference data that helps in assigning a risk score to the event.

In an embodiment, lookup tables 202 can be populated with data independently from baselining ML models 201. Independent data population includes calculating statistical counters of events, event fields, and sets of events, including both generic events and extended events. Lookup tables 202 serve multiple functions within the system 200. Firstly, lookup tables 202 can operate as a reference for training baselining ML models 201 to produce correlated event scores. The statistical data in the lookup tables 202 helps the ML models understand the frequency and patterns of different events, improving the accuracy of the training process. Baselining ML models 201 can use lookup tables 202 as an additional input for event scoring. The pre-calculated statistical data and event patterns in the lookup tables 202 provide valuable context, helping the ML models make more informed and accurate scoring decisions. Secondly, lookup tables 202 and baselining ML models 201 can operate in parallel, providing two distinct scores for each event that can be superimposed to enhance the overall risk assessment. By leveraging the independent and complementary functionalities of lookup tables 202 and baselining ML models 201, the event scoring unit 130 can deliver precise and reliable risk assessments, according to an embodiment.

In one embodiment, baselining ML models and serialized ML model 201 can run within the event enrichment unit 140. The baselining ML model 201 operates within the event enrichment unit 140 to determine which events or event fields are necessary for extending the event-in-operation data, determining additional data that is related to the event-in-operation and relevant to abnormal or risky patterns that are a base for event-in-operation score calculation.

In one embodiment, the event enrichment unit 140 and event scoring unit 130 use the baselining ML model jointly, whether the ML model is executed within the event scoring unit, the event enrichment unit, or on a dedicated server. The baselining ML model provides a consistent framework for assessing event attributes and detecting deviations from normal behavior patterns. By using the same model, discrepancies that could arise from different models are avoided, enhancing coherence across the system, and computational resources consumption is decreased.

In an embodiment, detection engine 160 is configured for the advanced analysis and correlation of security events to detect potential threats accurately. Detection engine 160 operates in multiple stages to enhance detection quality while maintaining real-time analysis capabilities. In an embodiment, detection engine 160 integrates with event scoring unit 130 and event enrichment unit 140 to implement multi-staged detection operations. Detection engine 160 performs each stage of threat detection with a context of comprehensive risk assessments and enriched data, thus supporting stateless and stateful modes of threat detection.

In the first stage, detection engine 160 processes generic events from event router 110, applying predefined security rules to identify suspicious patterns and activities. Before events are processed at the first stage, the generic events can be scored by event scoring unit 130. Risk scores of the generic events help prioritize the first-stage processing, ensuring that higher-risk events receive immediate attention and further analysis.

Next, the first-stage detections are correlated with enriched events from event enrichment unit 140. The event enrichment unit 140 adds context to the raw or generic events, incorporating data from internal sources such as user behavior analytics and historical event databases, as well as external sources like threat intelligence feeds and security alerts. Enriched event context allows the detection engine 160 to better understand the significance of each event, thereby distinguishing between benign anomalies and genuine threats.

In the second stage, detection engine 160 uses enriched data to perform a deeper analysis of the initial detections. The enriched context allows detection engine 160 to validate and refine its findings, leading to the generation of more accurate and reliable second-stage detections, or detection verdicts. Detection engine 160 verdicts reflect a comprehensive evaluation of the events, combining rule-based initial detections, risk scores, and enriched contextual data.

The multi-staged detection process therefore integrates event scoring and enrichment to enhance the quality of threat detection. Event scoring provides a quantitative assessment of risk, guiding the prioritization and focus of the detection efforts. Event enrichment supplies the necessary context to understand the broader implications of each event, improving the accuracy of the final detection verdicts.

By maintaining real-time analysis throughout rule-based detection and correlation, detection engine 160 responds promptly to emerging threats. The combination of rule-based initial detection and enriched data correlation allows the engine to perform thorough analysis without sacrificing speed, ensuring both high detection quality and real-time responsiveness, according to an embodiment.

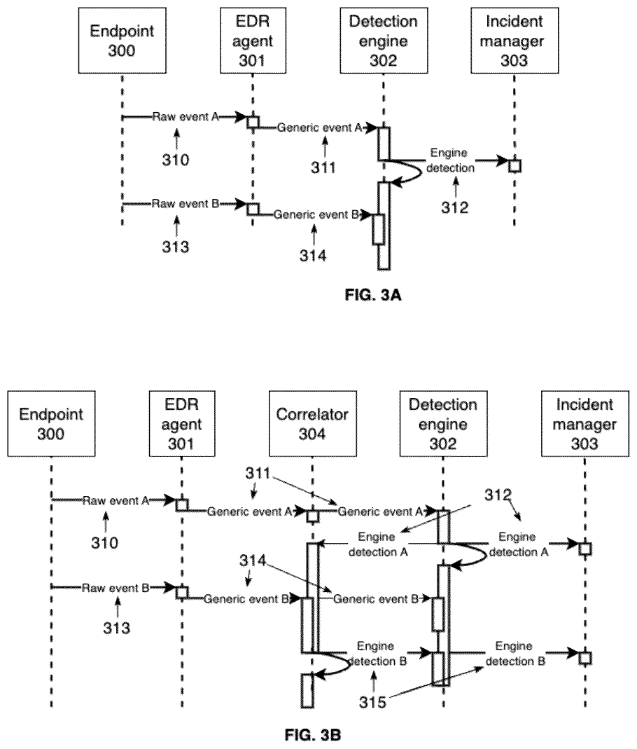

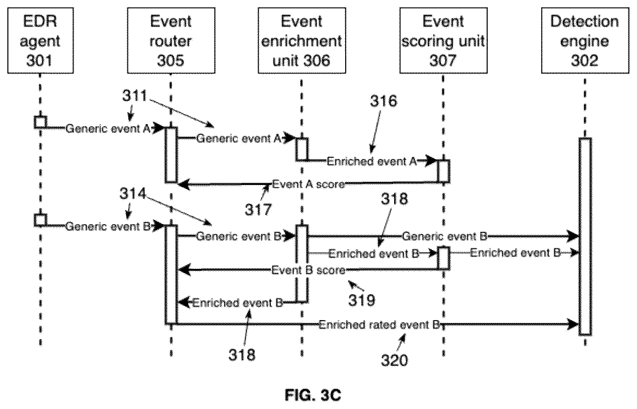

Referring to FIG. 3A, a data flow diagram of a threat detection system is depicted, in accordance with an embodiment.

In an embodiment, the system includes an endpoint 300, an EDR agent 301, a detection engine 302, and an incident manager 303. The data flow begins at endpoint 300, where raw security events are generated. Raw events, such as raw event A 310 and raw event B 313, are detected and collected by EDR agent 301. The EDR agent 301 normalizes raw events into generic events, represented as generic event A 311 and generic event B 314.

The generic events are then forwarded to detection engine 302. Within detection engine 302, generic events are analyzed against predefined security rules to identify suspicious patterns and activities. For example, detection engine 302 processes generic event A 311 and generates a detection of a threat 312, referred to as engine detection or detection, if a threat is identified. Similarly, generic event B 314 is processed, and if deemed suspicious, another detection of a threat is generated at detection engine 302. In the depicted data flow, generic event B 314 is not assessed as suspicious, and another engine detection was not registered. In an embodiment, generated engine detections can be related to a one type of threat. In another embodiment, generated engine detections can be related to different types of threats. Example systems, shown on FIG. 3A do not include a correlator. In embodiments, event A 311 and event B 314 and threat detections are combined, such as by engine detection 312, into a single incident.

The generated detection 312 is sent to incident manager 303, which is configured for handling the security incidents. Incident manager 303 coordinates the response actions based on the detected threats, ensuring appropriate measures are taken to mitigate potential risks.

In an embodiment, the detections, such as engine detection 312, are stateless, meaning that the detection engine 302 does not retain any context or state information about the events in course or after processing. Consequently, if a detection 312 related to event A is identified, it is not further corrected or re-evaluated in the case of a possible false positive. In contrast to traditional approaches, which can lead to inefficiencies in threat detection and response, embodiments described herein can dynamically reassess and refine detections based on additional context or data, according to an embodiment.

Referring to FIG. 3B, a data flow diagram of a threat detection system with event correlation is depicted, in accordance with an embodiment. FIG. 3B depicts how engine detections are correlated with subsequent events to improve threat detection accuracy.

In an embodiment, the system includes an endpoint 300, an EDR agent 301, a correlator 304, a detection engine 302, and an incident manager 303. The data flow begins at endpoint 300, where raw security events are generated. Raw events, such as raw event A 310 and raw event B 313, are detected and collected by EDR agent 301. The EDR agent 301 normalizes raw events 310, 313 into generic events, represented as generic event A 311 and generic event B 314.

The generic events 311, 314 are then forwarded to detection engine 302. Within detection engine 302, ranked and enriched events are analyzed to identify suspicious patterns and activities. For example, detection engine 302 processes generic event A 311 and generates a detection A 312 if a threat is identified. Initial detection 312 is then sent to correlator 304.

Correlator 304 retains context and state information about the detections and continuously monitors for subsequent events related to context. When generic event B 314 is detected by EDR agent 301 and forwarded to detection engine 302, it generates another detection, detection B 315. Correlator 304 then correlates detection A 312 with the new detection, detection B 315, to determine if there is a relationship between them.

The correlation process includes comparing the attributes and context of the engine detections to identify patterns or sequences indicating a more significant threat. A correlation stage enhances detection quality by leveraging the context provided by multiple related events. For example, if detection A 312 is a suspicious file access and detection B 315 is a related network connection, correlator 304 identifies the combined activity as a coordinated attack, enhancing the detection accuracy. The results of the correlated detections are then sent to incident manager 303, which coordinates the response actions based on the correlated threats and provides a context of related events being a cause of the registered incident.

Referring to FIG. 3C, a data flow diagram of a threat detection system with advanced event scoring is depicted, in accordance with an embodiment. FIG. 3C shows how the system 200 incorporates event scoring and enrichment to enhance threat detection accuracy.

In an embodiment, the system includes an EDR agent 301, an event router 305, an event enrichment unit 306, an event scoring unit 307, a detection engine 302, and an incident manager 303. The data flow begins at EDR agent 301, where raw events, such as raw event A 310 and raw event B 313, are detected and collected by EDR agent 301. The EDR agent 301 normalizes raw events into generic events, represented as generic event A 311 and generic event B 314. The generic events 311, 314 are forwarded to event router 305. Event router 305 directs events to both the event enrichment unit 306 and the event scoring unit 307. Generic event A 311 is sent to event enrichment unit 306, where it is enriched with additional context, resulting in enriched event A 316. Simultaneously, generic event A 311 is sent to event scoring unit 307, which assigns a score to the event based on its risk level. The score, referred to as event A score 317, indicates the likelihood that the event represents a security threat. If event A score 317 is below a predefined threshold, event router 305 filters the event, and the event is not forwarded for further analysis by detection engine 302 and enriched scored event A 318 is filtered out due to a low score.

Generic event B 314 undergoes a similar process of enrichment and scoring, resulting in enriched event B 319 and event B score 318. If the score of event B 318 exceeds the threshold, the enriched scored event B 320 is sent to detection engine 302 for further analysis. Detection engine 302 processes enriched scored event B 320 by applying predefined security rules and correlating it with other events to detect potential threats.

The correlation process within detection engine 302 involves multi-stage analysis, where the initial detection of generic event B 314 is correlated with enriched event B 319, the final enriched scored event B 320. The final detection results are sent to incident manager 303.

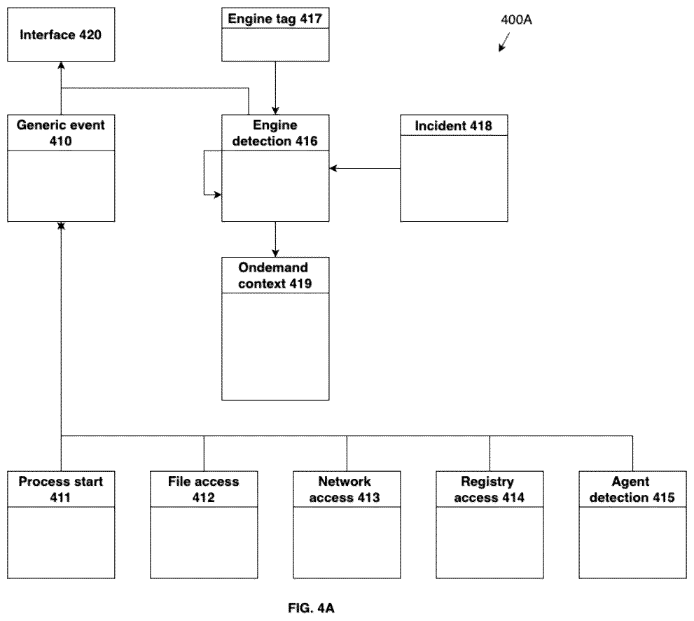

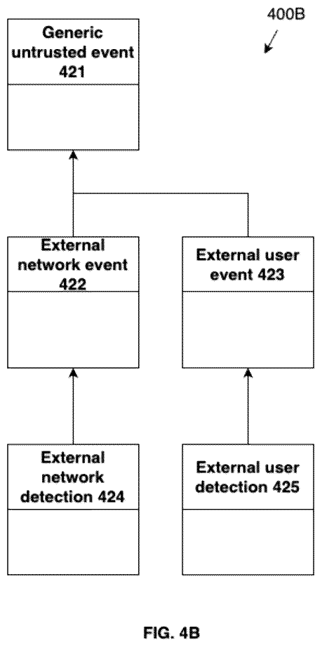

Referring to FIG. 4A, a block diagram of a data structure for ML-based event analysis is depicted, in accordance with an embodiment. FIG. 4A depicts the data types used in datasets for training and inference of baselining, event scoring, and enrichment operations, detection engine operation, including training and inference. In another embodiment, the data structure represents the context for generating lookup tables.

In FIG. 4A, the key object type is a generic event 410, which relates to various event types such as Process start 411, File access 412, Network access 413, Registry access 414, and Agent detection 415, used for event enrichment, event pattern identification and event linkage. Generic events are used to form the basis for initial event scoring via an interface 420 operation input.

The Engine detection 416 object type is configured for storing the scored events and generating detections. The detections can be tagged with an engine tag 417, which includes time parameters, referred to as time-window, thereby determining event correlation lifetime. According to an embodiment, the engine tag 417 acts as a temporal marker, essential for tracking the lifecycle and correlation of events across different times and sources. Engine tag 417 aids in identifying the sequence and timing of events, which is needed for temporal analysis and correlation.

The detection outcomes are linked with incidents 418, representing threat detection. For further analysis and validation, an on-demand context 419 object type can be linked, which pulls additional information as required for enhancing the detection accuracy.

The data structure supports both stateless and stateful analysis, allowing sophisticated detection capabilities. The engine can retain event contexts over time, supporting features like temporal reasoning, sliding time windows, and cross-event correlation. The structured data allows the system to adapt dynamically to evolving threats and enrich events with contextual information from both internal and external sources, enhancing the overall detection efficacy.

In an embodiment, data object types contain the following fields and parameters: Process start 411: WinProcStart (proc_sha1: String; proc_md5: String), File access 412: WinFileAccess (file_op: String; file_name: String; file_path: String; file_sha256: String), Network access 413: WinNetAccess (protocol: String; net_dst_ip: String; net_dst_port: Integer; net_src_ip: String; net_src_port: Integer; net_src_iot: Boolean; net_src_name: String; net_src_mac: String; net_src_vn: String; net_src_iot_cat: String), Registry access 414: WinRegAccess (reg_operation: String; reg_key: String; reg_value_type: String; reg_value_name: String; reg_value_data: String; reg_okey: String; reg_ovalue_data: String), Agent detection 415: WinAgentDetection (det_type: String; det_name: String; det_score_conf: Integer; det_score_pop: Integer; det_teid: Integer; det_taid: Integer), GenericEvent (id: UUID; event_time: Date; host_name: String; agent_id: UUID; resource_id: UUID; customer_id: UUID; customer: String; source_type: String; parent_name: String; parent_oname: String; parent_args: String; parent_path: String; parent_pid: Integer; parent_start:Date; parent_gpid:UUID; parent_sha256: String; proc_name: String; proc_oname: String; proc_args: String; proc_path: String; proc_pid: Integer; proc_start: Date; proc_user: String; proc_upn: String), EngineDetection (id: UUID; timestamp: Date; name: String; description: String; severity: Integer; customer_id: UUID; customer: String), EngineTag (tlt: String).

Referring to FIG. 4B, a block diagram of a data structure for ML-based event analysis with external event sources is depicted, according to an embodiment. In an embodiment, the data structure includes a generic untrusted event 421, which represents key events detected within the system. The generic untrusted event 421 can be further classified into more specific types of events based on additional information and context provided by external sources. For example, the generic untrusted event 421 can be correlated with an external network event 422, which represents network-related activities such as unusual traffic patterns or unauthorized access attempts. The external network event 422 is associated with external network detection 424, providing detailed analysis and correlation data from network monitoring systems or third-party threat intelligence feeds.

Similarly, the generic untrusted event 421 can be linked to an external user event 423, representing user-related activities such as anomalous login attempts or suspicious behavior patterns. The external user event 423 is further connected to external user detection 425, which includes detailed insights from user behavior analytics or identity and access management systems.

The depicted hierarchical data structure 400B allows for the enrichment of the initial generic untrusted event 421 with additional context and specificity, thereby enhancing the accuracy and effectiveness of threat detection. Using external sources of data and integrating external source events into the event analysis process, embodiments can provide a more comprehensive and nuanced understanding of potential security threats, facilitating more informed and effective responses.

According to an embodiment, external network detection 424 and external user detection 425 can provide enrichment data in the following format: ExtNetDetection (name: String; severity: String), ExtUserDetection (name: String; severity: String).

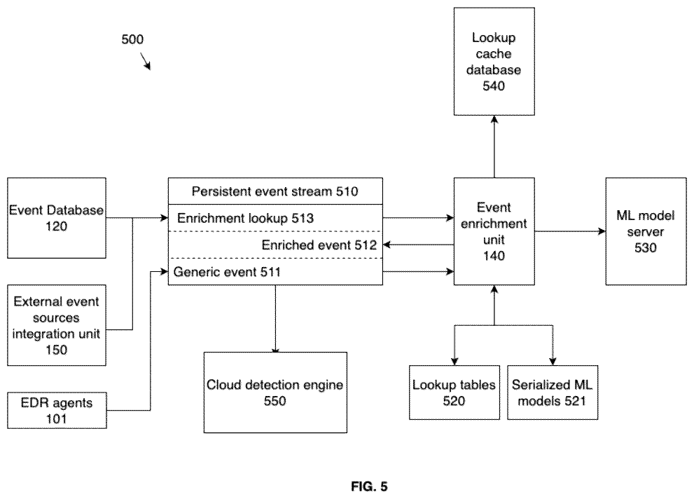

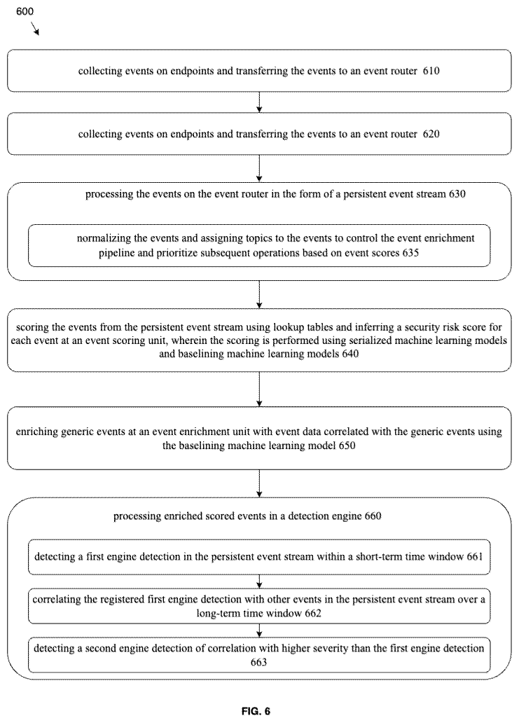

Referring to FIG. 5, a block diagram of a system 500 of advanced event scoring and correlation for threat detection based on a persistent event stream is depicted, in accordance with an embodiment. The system 500 comprises EDR agents 101, an event database 120, a persistent event stream 510, an event enrichment unit 140, lookup tables 520, serialized ML models 521, an ML model server 530, a lookup cache database 540, a cloud detection engine 550, and an external event sources integration unit 150.

In an embodiment, EDR agents 101 publish raw security events to the persistent event stream 510. In the persistent event stream 510, events are accessible to other system components for further processing. Raw events are converted to generic events 511. The event enrichment unit 140 reads generic events 511 from the persistent event stream 510 and performs enrichment operations by incorporating additional context from external sources. The enriched events are then published back to the persistent event stream 510 as enriched events 512.

In an embodiment, the persistent event stream 510 organizes events by “topics” to persist event data. A dedicated process of the event router interacts with topics, retrieving raw events and joining them with enrichment information based on a specific key. The enriched events are then transferred to a “processed event topic,” from which events are subsequently directed to the detection engine. The event enrichment unit 140 utilizes lookup tables 520 and serialized ML models 521 to assess and enrich the events. The lookup tables 520 are populated with statistical and contextual data that assist in the enrichment process, while the serialized ML models 521 provide ML-based insights. The enrichment application reads from the lookup tables 520 and performs local lookups and inference using the serialized ML models 521, maintained and updated by the ML model server 530, which communicates with the lookup cache database 540 to store and retrieve the operational data.

In one embodiment, the persistent event stream 510 serves as a central hub for event data that continuously provides all relevant information for analysis, allowing the cloud detection engine 550 to access both generic events 511 and enriched events 512 in real-time. The cloud detection engine 550 processes events with a score from persistent event stream 510 to detect potential security threats, thus leveraging the enriched context to improve detection accuracy and reduce false positives. Additionally, the external event sources integration unit 150 is configured for the enrichment of events by incorporating on-demand data from external threat intelligence feeds and other relevant sources.

Referring to FIG. 6, a flowchart of a method 600 of advanced event scoring and correlation for threat detection is depicted, in accordance with an embodiment.

In an embodiment, the method 600 begins with collecting events on endpoints and transferring the events to an event router at 610. Subsequently, the events are processed on the event router in the form of a persistent event stream at 620. In an embodiment, event processing at the event router includes normalizing the events and assigning topics to the events to control the event enrichment pipeline and prioritize subsequent operations based on event scores at 630.

In an embodiment, the method 600 continues with scoring the events from the persistent event stream using lookup tables and inferring a security risk score for each event at an event scoring unit at 640. The scoring is performed using serialized ML models and baselining ML models. The generic events are then enriched at an event enrichment unit with event data correlated with the generic events using the baselining ML model at 650. The enrichment is performed in a prioritized manner according to the event score and related topics.

The method 600 further includes processing enriched scored events in a detection engine at 660. Detection engine operations comprises detecting first engine detection in the persistent event stream within a short-term time window at 661, correlating the registered first engine detection with other events in the persistent event stream over a long-term time window at 662, and detecting a second engine detection of correlation with higher severity than the first engine detection at 663.

In one embodiment, a short-term time window is a defined period during which security events are analyzed for immediate threat detection. The short-term time window is limited by the common duration of suspicious operations performed by malware, typically ranging from seconds to a few minutes. The short-term time window can also be defined according to the amount of operational memory available for analyzing security events in cache, ensuring efficient processing and rapid detection of threats.

In another embodiment, a long-term time window, referred to as a second time window, spans a more extended period, reflecting the average duration over which attacks or security incidents may unfold. The long-term time window can range from hours to days or even longer, allowing the system to correlate events over a prolonged time frame. The long-term time window can be defined according to an average period of attacks or incidents thereby allowing for identification of complex, persistent threats.

In an embodiment, the detection engine processes the enriched scored events by applying predefined security rules to identify potential threats. A first detection is based on immediate analysis within a short-term time window, capturing real-time anomalies and potential threats. The events that triggered the first detection are then further analyzed and correlated with other events in the persistent event stream over an extended period, known as the long-term time window. Event correlation evaluates patterns and connections between multiple events to detect more complex and sophisticated threats that can not be apparent in real-time analysis alone.

The second detection is generated by aggregating the correlated events, assigning a higher severity to the detection based on the cumulative risk and context provided by the long-term analysis.

In an embodiment, a security incident is registered (e.g. with the endpoint and/or other system component) when the second detection has a severity higher than a given threshold. In one aspect, the threshold can be a predefined value. In another aspect, the threshold can be predefined but modifiable.

Detection severity is a probabilistic characteristic that quantifies the likelihood and potential impact of a detected threat. Severity of engine detection applies to both rule-based and machine learning ML-based detections within a threat detection system.

For rule-based detection, severity is calculated based on predefined rules and their associated risk levels. For example, if a detection rule identifies an unauthorized access to a critical system file, the severity is assigned a high value due to the potential for significant damage. A detection rule identifying a minor policy violation is assigned a low severity. The calculation includes assessing the rule's conditions and the context in which the event occurs, such as time of day, user identity, and historical behavior patterns.

In ML-based detection, severity is derived from the output of ML models, which analyze various features of the events to predict the likelihood of a threat. The models are trained on historical data and use statistical analysis to assign a severity score to each event. For example, an ML model might analyze network traffic patterns to detect anomalies. An unusual spike in data transfer from a specific endpoint could result in a high severity score if such behavior is typically associated with data exfiltration attempts. If the same pattern occurs during a scheduled backup, the severity might be lower, indicating normal behavior.

When an event pattern is identified, the system calculates the probability that this pattern represents a threat. For example, a series of failed login attempts followed by a successful login from an unusual location might be flagged with a high severity. However, if the same pattern is observed from a trusted user during travel, the severity might be adjusted to reflect normal behavior with a lower risk.

Both event scores and detection severities are probabilistic measures, but they differ in scope and application. The event score is typically used to assess the risk of single events as they occur, while detection severity evaluates the overall threat level based on aggregated events and patterns.

According to an embodiment, the baselining ML model, serialized ML model, lookup table, and ML-based detection engine maintain consistency in terms of event data, event format, and event processing prioritization. Event data consistency allows seamless integration and efficient processing across different units of the system, allowing for advanced scaling capabilities for multiple detection engines and real-time access to event data.

1. A method for adaptive threat detection in a computing system comprising a microprocessor, memory, and a plurality of endpoints, the method comprising:
collecting events on the endpoints and sending the events to an event router;
processing the events on the event router under program control of the microprocessor in the form of a persistent event stream, wherein the processing includes:
normalizing the events and assigning topics to the events to prioritize event enrichment operations and subsequent detection engine operations based on event scores, wherein normalizing the events further comprises converting the events into a standardized event format;
scoring the events from the persistent event stream using at least one of a lookup tables, a serialized machine learning model or a baselining machine learning model, wherein each event is scored to indicate a likelihood that the event represents a security threat;
enriching generic events at an event enrichment unit using at least one of the lookup tables or the baselining machine learning model, wherein the enriching includes incorporating at least one additional context for a given generic event, and wherein the enriching is prioritized according to the event score and at least one topic of the generic event to create enriched scored events;
publishing, by the event enrichment unit, the enriched scored events to the persistent event stream by joining standardized event data with the at least one additional context, wherein the persistent event stream is at least partially organized by topics;
processing the enriched scored events from the persistent event stream in a detection engine, wherein the processing includes:
detecting a first detection in the persistent event stream within a short-term time window, the first detection comprising an immediate potential threat,
tagging the first detection with a temporal marker for association in an event correlation lifetime,
retrieving other events in the persistent event stream,
correlating the registered first detection with the other events in the persistent event stream within a long-term time window according to the event correlation lifetime, wherein the registered first detection has a relationship to the other events by at least one of the standardized event data or the at least one additional context, and
detecting a second detection using the correlating, wherein the second detection comprises a more complex potential threat with higher severity than the first detection; and
registering a security incident when the second detection has a severity higher than a predefined threshold;
wherein the baselining machine learning model, the serialized machine learning model, the lookup table, and the machine learning-based detection engine use the standardized event format.

2. The method of claim 1, wherein the events collected on endpoints include process start, file access, network connections, and registry changes.

3. The method of claim 1, wherein the topics assigned to events include event attribute source, type, score or severity.

4. The method of claim 1, wherein the lookup tables used for scoring are generated based on historical event data stored in an event database configured to collect all events processed in the persistent event stream.

5. The method of claim 1, wherein the baselining machine learning model is trained using historical event data to recognize normal behavior patterns and detect deviations.

6. The method of claim 1, wherein the event enrichment unit uses additional data sources including third-party threat intelligence feeds, system logs, network traffic data, and user behavior analytics for event enrichment.

7. The method of claim 1, wherein the first detection is registered based on predefined security rules applied to the enriched scored events.

8. The method of claim 1, wherein the second time window for correlating events is dynamically adjusted based on the severity of the first engine detection.

9. The method of claim 1, wherein the second detection of higher severity is based on the aggregation of multiple correlated events and correlated events scores.

10. The method of claim 1, wherein the event enrichment unit prioritizes the enrichment of events based on event scores and related event topics.

11. A system for adaptive threat detection in a computing system, the system comprising:
an endpoint detection and response (EDR) agent configured to collect events on an endpoint and transfer the events to an event router;
at least one processor and memory operably coupled to the at least one processor;
instructions that, when executed by the at least one processor, cause the at least one processor to implement:
the event router, the event router configured to process the events in the form of a persistent event stream, wherein the processing includes:
normalizing the events and assigning topics to the events to control the event enrichment pipeline and prioritize subsequent operations based on event scores, wherein normalizing the events further comprises converting the events into a standardized event format;
an event scoring unit configured to score the events from the persistent event stream using lookup tables and infer a security risk score for each event, wherein the scoring is performed using serialized machine learning models and baselining machine learning models, wherein each event is scored to indicate a likelihood that the event represents a security threat;
an event enrichment unit configured to:
enrich generic events using the baselining machine learning model, wherein the enriching includes incorporating at least one additional context for a given generic event, and wherein the enrichment is performed in a prioritized manner according to the event score and at least one topic of the generic event to create enriched scored events, and
publish the enriched scored events to the persistent event stream by joining standardized event data with the at least one additional context, wherein the persistent event stream is at least partially organized by topics;
a detection engine configured to process the enriched scored events from the persistent event stream, wherein the processing includes:
detecting a first detection in the persistent event stream within a short-term time window, the first detection comprising an immediate potential threat,
tagging the first detection with a temporal marker for association in an event correlation lifetime,
retrieving other events in the persistent event stream,
correlating the registered first engine detection with the other events in the persistent event stream over a long-term time window according to the event correlation lifetime, wherein the registered first detection has a relationship to the other events by at least one of the standardized event data or the at least one additional context,
detecting a second detection using the correlating, wherein the second detection comprises a more complex potential threat with higher severity than the first engine detection, and
registering a security incident when the second detection has a severity higher than a predefined threshold;
wherein the baselining machine learning model, serialized machine learning model, lookup table, and machine learning-based detection engine use the standardized event format.

12. The system of claim 11, wherein the EDR agent is configured to collect events including process start, file access, network connections, and registry changes.

13. The system of claim 11, wherein the topics assigned to events include event attribute source, type, score or severity.

14. The system of claim 11, wherein the lookup tables used for scoring are generated based on historical event data stored in an event database configured to collect all events processed in the persistent event stream.

15. The system of claim 11, wherein the baselining machine learning models are trained using historical event data to recognize normal behavior patterns and detect deviations.

16. The system of claim 11, wherein the event enrichment unit uses additional data sources including third-party threat intelligence feeds, system logs, network traffic data, and user behavior analytics for event enrichment.

17. The system of claim 11, wherein the first detection is registered based on predefined security rules applied to the enriched scored events.

18. The system of claim 11, wherein the second time window for correlating events is dynamically adjusted based on the severity of the first engine detection.

19. The system of claim 11, wherein the second detection of higher severity is based on the aggregation of multiple correlated events and correlated events scores.

20. The system of claim 11, wherein the event enrichment unit prioritizes the enrichment of events based on event scores and related event topics.
